(19) United States
(12) Patent Application Publication
(10) Pub. No.: US 2020/0133036 A1
(43) Pub. Date: Apr. 30, 2020

(54) COLOR-CHANGING LIGHT-ADJUSTING LIQUID CRYSTAL DEVICE AND LIGHT ADJUSTING METHOD THEREOF

(71) Applicant: SHENZHEN GUOHUA OPTOELECTRONICS CO., LTD., Shenzhen, Guangdong (CN)

(72) Inventors: Guofu ZHOU, Shenzhen, Guangdong (CN); Yuanyuan ZHAN, Shenzhen, Guangdong (CN); Dirk Jan BROER, Shenzhen, Guangdong (CN); Danqing LIU, Shenzhen, Guangdong (CN); Albertus Petrus Henricus Johannes SCHENNING, Shenzhen, Guangdong (CN)

(73) Assignee: SHENZHEN GUOHUA OPTOELECTRONICS CO., LTD., Shenzhen, Guangdong (CN)

(21) Appl. No.: 16/481,083

(22) PCT Filed: Jul. 6, 2018
(86) PCT No.: PCT/CN2018/094857

§ 371 Date: Jul. 26, 2019

(30) Foreign Application Priority Data
Aug. 18, 2017 (CN) 201710714176.7

(51) Int. Cl. G02F 1/137; G02F 1/1337

(52) U.S. Cl. CPC G02F 1/137; G02F 1/1337; G02F 2202/043; G02F 2001/13756; G02F 2001/133738; G02F 2001/13712; G02F 2001/13706; G02F 2001/133742

(57) ABSTRACT

A color-changing light-adjusting liquid crystal device and a light-adjusting method may include a main liquid crystal and a dichroic dye, which may be filled between substrates disposed oppositely, in a non-powered state. The main liquid crystal may be subjected to a specific arrangement orientation under an induction of an alignment layer, in a powered state, and the main liquid crystal may be subjected to a reorientation. Dichroic dye molecules may be rotated along with the reorientation of the main liquid crystal so as to scatter incident light in a visible spectrum, convert a light-transmitting state into a light-scattering state at a macro level, and display a color of the dichroic dye in the main liquid crystal, thus implementing light adjustment. The color-changing light-adjusting liquid crystal device does not contain a polymer network, so that a polymerization process is not needed and a polymer aging is avoided.

### CROSS-REFERENCE TO RELATED APPLICATIONS

This application is a national phase application of International Application No. PCT/CN2018/094857, filed Jul. 6, 2018, which claims priority to CN 201710714176.7, filed Aug. 18, 2017, all of which are hereby incorporated herein by reference.

### TECHNICAL FIELD

The present disclosure relates to the field of display technologies, and more particularly, to a color-changing light-adjusting liquid crystal device and a light-adjusting method thereof.

### BACKGROUND

An electrochromic intelligent window controls a light transmittance of glass through a voltage and makes the color change rapidly, and the technology has a good application prospect in the fields of energy conservation and environmental protection. Most of the existing color intelligent window technologies are based on a system of a polymer dispersed liquid crystal (PDLC) or a polymer stabilized liquid crystal (PSLC), the two systems are both polymer networks obtained by adding dichroic dye molecules to a mixture of a main liquid crystal, a photoinitiator, etc., the arrangement of the dichroic dye molecules in the system is easily affected by the migration of reaction monomer molecules during a polymerization process, thus resulting in irregular arrangement of molecules at the later stage, so that the dye molecules are in an obvious scattering state before being powered and have little color contrast with the dye molecules after being powered. Due to the high costs of the used polymer materials, the price of the intelligent window has remained relatively high, the current price is several thousand yuan per square meter, and meanwhile, due to polymerization and other processes, a preparation process takes a long time, and due to an aging phenomenon of an organic polymer, a service life of the intelligent window is greatly reduced.

### SUMMARY

The object of the present disclosure is to provide a color-changing light-adjusting liquid crystal device, which has solved the problems in the prior art that the color contrast before and after being powered is not large, the preparation process takes a long time, the production cost is high, and the service life is short due to the use of a system containing a polymer network.

The technical solutions adopted in the present disclosure are as follows.

The present disclosure provides a color-changing light-adjusting liquid crystal device, which comprises two substrates disposed oppositely, wherein the substrate comprises a light-transmitting substrate, a conducting layer and an alignment layer which are sequentially disposed from outside to inside, the alignment layers of the two substrates are disposed oppositely, an adjusting area is formed between the two substrates, a liquid crystal mixture is filled in the adjusting area, the liquid crystal mixture comprises a main liquid crystal and a dichroic dye, and the main liquid crystal has a dielectric anisotropy.

In some implementations, the main liquid crystal is a negative liquid crystal, and the alignment layer is a vertical alignment layer.

In some other implementations, the main liquid crystal is a positive liquid crystal, and the alignment layer is a parallel alignment layer.

The alignment layer is a polyimide alignment layer.

The-liquid crystal mixture comprises 90.0 wt % to 99.99 wt % of the main liquid crystal and 0.01 wt % to 10.0 wt % of the dichroic dye.

The dichroic dye is at least one of fluorescent green, a purple dichroic dye and an orange dichroic dye.

A height of the adjusting area is 5 μm to 50 μm.

The adjusting area is also filled with a spacer for supporting the height of the adjusting area.

The color-changing light-adjusting liquid crystal device further comprises a power supply component, wherein two poles of the power supply component are respectively electrically connected with two conducting layers.

Further, a working voltage of the power supply component is 7 V to 50 V.

Further, a working frequency of the power supply component is 50 Hz to 1000 Hz.

Further, the salt from which ions are ionized is a quaternary ammonium salt cationic surfactant.

The present disclosure further provides a light-adjusting method for the light-adjusting device above, light-adjusting method comprises by applying an AC voltage, converting the main liquid crystal from an vertical orientation arrangement to an parallel orientation arrangement, with respect to the substrate, and causing the salt from which ions are ionized to move under a formed AC electric field to disorganize the orientation arrangements of the main liquid crystal, thereby to adjust transmission and scattering of visible light for light adjustment.

The present disclosure further provides a light-adjusting method for the color-changing light-adjusting liquid crystal device above, the main liquid crystal is controlled to be changed from a specific orientation arrangement to an another orientation arrangement through an applied AC voltage, reorientation occurs, impurity ions contained in the liquid crystal mixture and ions generated by the color-changing light-adjusting liquid crystal device under an AC electric field move back and forth between the substrates, which disorganizes the orientation arrangement of the main liquid crystal, enables the dichroic dye and the liquid crystal molecules to rotate, and adjusts transmission and scattering of visible light, thus realizing light adjustment.

The present disclosure has the beneficial effects as follow.

The present disclosure provides a color-changing light-adjusting liquid crystal device, which is filled with the main liquid crystal and the dichroic dye, in an unpowered state, the main liquid crystal is in a specific orientation arrangement under induction of the alignment layer, in a powered state, the main liquid crystal is reoriented, dichroic dye molecules rotate along with the reorientation of the main liquid crystal, and meanwhile, a very small amount of impurities contained in the dichroic dye and the main liquid crystal can also cause electrodynamic instability along with the reorientation arrangement of the main liquid crystal, and ions formed by excitation of the alignment layer by the electric field can also participate in the electrodynamic instability, thus causing irregular arrangement of the dichroic dye molecules, scattering incident light in a visible light waveband, and presenting the color of the dichroic dye in the main liquid crystal, so as to realize light adjustment. On the premise that the color-changing light-adjusting liquid crystal device provided by the present disclosure achieves light adjustment, since the system does not have the polymer network, the main liquid crystal and the dichroic dye can be directly mixed and filled into the liquid crystal cell, so that the preparation process is simple, a reaction monomer and a polymerization process are not needed, and a polymer aging is avoided, thus reducing the production cost and extending the service life of the color-changing light-adjusting liquid crystal device.

### BRIEF DESCRIPTION OF THE DRAWINGS

FIG. 1 is a structure diagram of a color-changing light-adjusting liquid crystal device in an unpowered state; and

FIG. 2 is a structure diagram of the color-changing light-adjusting liquid crystal device in a powered state.

### DETAILED DESCRIPTION

The conception, specific structure and generated technical effects of the present disclosure will be clearly and completely described hereinafter with reference to the implementations and the drawings for fully understanding the objects, features and effects of the present disclosure. Apparently, the described implementations are only some implementations of the present disclosure rather than all the implementations, and other implementations obtained by those skilled in the art based on the implementations of the present disclosure without any creative works shall all fall within the protection scope of the present disclosure.

### First Implementation

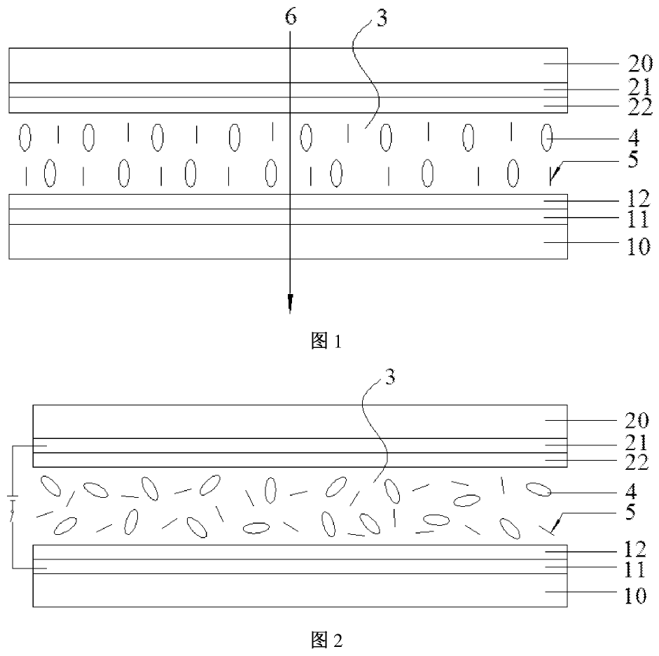

The present disclosure provides a color-changing light-adjusting device, a structure of which is shown in FIG. 1, the color-changing light-adjusting device comprises a first substrate and a second substrate which are oppositely disposed, wherein the first substrate comprises a first transparent glass substrate 10, a first ITO conducting layer 11 and a first polyimide vertical-alignment layer 12 which are sequentially disposed, the second substrate comprises a second transparent glass substrate 20, a second ITO conducting layer 21 and a second polyimide vertical-alignment layer 22 which are sequentially disposed, the first polyimide vertical-alignment layer 12 of the first substrate and the second polyimide vertical-alignment layer 22 of the second substrate are oppositely disposed, an adjusting area 3 is formed between the first substrate and the second substrate, the adjusting area 3 has a height of 50 μm, a liquid crystal mixture is filled in the adjusting area 3, the liquid crystal mixture comprises a negative liquid crystal 4 and fluorescent green 5, a mass fraction of the fluorescent green 5 in the liquid crystal mixture is 0.01%, in an unpowered state, the negative liquid crystal 4 is in orientation arrangement perpendicular to the transparent glass substrate under induction of the polyimide vertical-alignment layer, and visible light 6 may be transmitted out of the transparent glass substrate, thus presenting a light-transmitting state.

The present disclosure further provides a light-adjusting method for the color-changing light-adjusting device above, with reference to FIG. 2, a power supply component is connected between the ITO conducting layer 11 and the ITO conducting layer 21, a working voltage of the power supply component is 7 V, a working frequency of the power supply component is 50 Hz, and the negative liquid crystal 4 is controlled to be reoriented by a voltage, changing from the orientation arrangement perpendicular to the substrate to the orientation arrangement parallel to the substrate in an unpowered state, and meanwhile, the filled fluorescent green 5 molecules rotate along with the reorientation of the negative liquid crystal under the formed AC electric field, and move irregularly along with the rapid movement of the impurity ions in the system at the same time. When the applied voltage reaches a certain value, the liquid crystal mixture may have a movement mode similar to “turbulent flow”, thus macroscopically changing from a light transmission state to a light scattering state, and presenting the color of the fluorescent green 5 in the negative liquid crystal 4, so as to realize light adjustment. Since the filled liquid crystal mixture has only small molecules, a driving voltage of the color-changing light-adjusting device provided by the present disclosure shall be smaller than that of the device based on the polymer network, so that the color-changing light-adjusting device may be driven by alternating current of household appliance in life without needing equipment of special frequency, thus being convenient to put into household. The implementation takes the fluorescent green as an example to illustrate, the actually filled dichroic dye is at least one of fluorescent green, a purple dichroic dye and an orange dichroic dye, and when the mixture of the dichroic dye is filled, the prepared color-changing light-adjusting liquid crystal device may present different colors by adjusting a ratio of different dyes.

### Second Implementation

The implementation provides a color-changing light-adjusting liquid crystal device, which has a structure same as that of the first implementation, but differs in that a height between the light adjusting areas is 5 μm, the alignment layer is a polyimide parallel-alignment layer, the liquid crystal mixture is a positive liquid crystal and a purple dichroic dye, the purple dichroic dye used in the implementation is RL013 in model No., a mass fraction of the purple dichroic dye in the liquid crystal mixture is 10%, the alignment layer is a polyimide parallel-alignment layer, and the color-changing light-adjusting liquid crystal device is connected with a power supply component with a voltage of 25 V and a frequency of 50 Hz to be in a powered state. For the color-changing light-adjusting liquid crystal device provided by the implementation in an unpowered state, a positive liquid crystal is subjected to orientation arrangement parallel to the substrate under induction of the polyimide parallel-alignment layer, when the power supply component is connected to be in a powered state, the positive liquid crystal is controlled to be reoriented by the applied AC voltage, changing from the orientation arrangement parallel to the transparent glass substrate to the orientation arrangement perpendicular to the transparent glass substrate, the purple dichroic dye rotates with the reorientation of the positive liquid crystal, and meanwhile, a very small amount of impurities contained in the positive liquid crystal and the dichromatic dye may also cause electrodynamic instability along with the reorientation arrangement of the positive liquid crystal, so that the dichromatic dye molecules are irregularly arranged, and the ions formed by excitation of the alignment layer by the electric field may also participate in the electrodynamic instability, thus further aggravating the change of the positive liquid crystal from the specific orientation arrangement to irregular arrangement, and controlling transmission and scattering of visible light, so as to realize light adjustment.

### Third Implementation

The implementation provides a color-changing light-adjusting liquid crystal device, which has a structure same as that of the first implementation, but differs in that a height between the light adjusting areas is 25 μm, the liquid crystal mixture is a negative liquid crystal and an orange dichroic dye, the orange dichroic dye used in the embodiment is RL002 in model No., a mass fraction of the RL002 in the liquid crystal mixture is 5%, and the color-changing light-adjusting liquid crystal device is connected with a power supply component with a voltage of 50 V and a frequency of 1000 Hz to be in a powered state.

### Fourth Implementation

The implementation provides a color-changing light-adjusting liquid crystal device, which has a structure same as that of the first implementation, but differs in that a height between the light adjusting areas is 40 μm, the liquid crystal mixture is a negative liquid crystal, a purple dichroic dye RL013 and an orange dichroic dye RL002, a mass fraction of a mixed dye of the purple dichroic dye RL013 and the orange dichroic dye RL002 in the liquid crystal mixture is 8%, and the color-changing light-adjusting liquid crystal device is connected with a power supply component with a voltage of 10 V and a frequency of 500 Hz to be in a powered state.

1. A color-changing light-adjusting liquid crystal device, comprising:
two substrates disposed oppositely, each comprising a light-transmitting substrate, a conducting layer and an alignment layer, sequentially disposed from outside to inside, the alignment layers of the two substrates are disposed oppositely;
an adjusting area, formed between the two substrates;
a liquid crystal mixture, filled in the adjusting area, and comprising a main liquid crystal with dielectric anisotropy and a dichroic dye.

2. The color-changing light-adjusting liquid crystal device according to claim 1, wherein the main liquid crystal is a negative liquid crystal, and the alignment layer is a vertical alignment layer.

3. The color-changing light-adjusting liquid crystal device according to claim 1, wherein the main liquid crystal is a positive liquid crystal, and the alignment layer is a parallel alignment layer.

4. The color-changing light-adjusting liquid crystal device according to claim 1, wherein the liquid crystal mixture comprises 90.0 wt % to 99.99 wt % of the main liquid crystal and 0.01 wt % to 10.0 wt % of the dichroic dye.

5. The color-changing light-adjusting liquid crystal device according to claim 1, wherein the dichroic dye is at least one of fluorescent green, a purple dichroic dye and an orange dichroic dye.

6. The color-changing light-adjusting liquid crystal device according to claim 2 wherein the dichroic dye is at least one of fluorescent green, a purple dichroic dye and an orange dichroic dye.

7. The color-changing light-adjusting liquid crystal device according to claim 3, wherein the dichroic dye is at least one of fluorescent green, a purple dichroic dye and an orange dichroic dye.

8. The color-changing light-adjusting liquid crystal device according to claim 4, wherein the dichroic dye is at least one of fluorescent green, a purple dichroic dye and an orange dichroic dye.

9. The color-changing light-adjusting liquid crystal device according to claim 1, wherein a height of the adjusting area is 5 μm to 50 μm.

10. The color-changing light-adjusting liquid crystal device according to claim 2, wherein a height of the adjusting area is 5 μm to 50 μm.

11. The color-changing light-adjusting liquid crystal device according to claim 3, wherein a height of the adjusting area is 5 μm to 50 μm.

12. The color-changing light-adjusting liquid crystal device according to claim 4, wherein a height of the adjusting area is 5 μm to 50 μm.

13. The color-changing light-adjusting liquid crystal device according to claim 1, further comprising a power supply component, wherein two poles of the power supply component are respectively electrically connected with two conducting layers.

14. The color-changing light-adjusting liquid crystal device according to claim 2, further comprising a power supply component, wherein two poles of the power supply component are respectively electrically connected with two conducting layers.

15. The color-changing light-adjusting liquid crystal device according to claim 3, further comprising a power supply component, wherein two poles of the power supply component are respectively electrically connected with two conducting layers.

16. The color-changing light-adjusting liquid crystal device according to claim 4, further comprising a power supply component, wherein two poles of the power supply component are respectively electrically connected with two conducting layers.

17. The color-changing light-adjusting liquid crystal device according to claim 13, wherein a working voltage of the power supply component is 7 V to 50 V.

18. The color-changing light-adjusting liquid crystal device according to claim 13, wherein a working frequency of the power supply component is 50 Hz to 1000 Hz.

19. A light-adjusting method for the color-changing light-adjusting liquid crystal device according to claim 1, comprising:
converting the main liquid crystal, by applying an AC voltage, from a specific orientation arrangement to an another orientation arrangement, reorientation occurs, impurity ions contained in the liquid crystal mixture and ions generated by the color-changing light-adjusting liquid crystal device under an AC electric field move back and forth between the substrates, which disorganizes the orientation arrangement of the main liquid crystal, enables the dichroic dye and the liquid crystal molecules to rotate, and adjusting transmission and scattering of visible light, realizing light adjustment.

20. A light-adjusting method for the color-changing light-adjusting liquid crystal device according to claim 2, comprising:
converting the main liquid crystal, by applying an AC voltage, from a specific orientation arrangement to an another orientation arrangement, reorientation occurs, impurity ions contained in the liquid crystal mixture and ions generated by the color-changing light-adjusting liquid crystal device under an AC electric field move back and forth between the substrates, which disorganizes the orientation arrangement of the main liquid crystal, enables the dichroic dye and the liquid crystal molecules to rotate, and adjusting transmission and scattering of visible light, realizing light adjustment.
